(19) United States
(12) Patent Application Publication
(10) Pub. No.: US 2002/0146584 A1
(43) Pub. Date: Oct. 10, 2002

(54) Process for producing sandwich structures between metallic and nonmetallic materials

(76) Inventor: Reinhard Fried, Nussbaumen (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 10/108,460

(22) Filed: Mar. 29, 2002

(30) Foreign Application Priority Data
Apr. 6, 2001 (DE) 101 17 128.5

(51) Int. Cl. B32B 7/00

(52) U.S. Cl. 428/609

(57) ABSTRACT

The invention relates to a process for producing sandwich structures (1) between metallic and nonmetallic materials, in which a bond layer (3) is applied to a surface (10) of a metallic base body (2), a nonmetallic material (5) is then applied to the bond layer, and in which the bond layer (3) is produced from individual welded-on rivets (4) which have a mushroom-like shape with web (8) and head (9). The process is characterized in that the mushroom-shaped rivets (4) are prefabricated in a first process step, in a second process step these rivets (4) are sorted for mechanical further processing, oriented and introduced into a welding unit (15) in such a manner that in a third process step the rivets (4) are successively welded, in each case by means of the free end of their web (8), onto the surface (10) of the base body (2), thereby forming anchor points for the nonmetallic material (5). The invention also relates to the sandwich structures (1) produced using the process.

### TECHNICAL FIELD

The invention relates to a process for producing sandwich structures between metallic and nonmetallic materials, in particular for the construction of gas and steam turbines, and to a sandwich structure between a metallic and a nonmetallic material produced using the process.

### PRIOR ART

The structure of sandwich structures comprising metallic and nonmetallic materials, such as for example the coating of metallic components used in the construction of gas and steam turbines with ceramic thermal barrier coatings, forms part of the generally known prior art.

A bond layer with a surface which is as rough as possible is sprayed onto a metallic surface of a base body, for example by means of plasma spraying or flame spraying. The roughness of the surface is used for the positively locking anchoring of the thermal barrier coating comprising a nonmetallic material which is likewise plasma-sprayed or flame-sprayed onto this surface. On account of the very different coefficients of thermal expansion between metals and nonmetallic materials, such as ceramics, these joins are usually only suitable up to a layer thickness of <500μm.

Components which are provided with thermal barrier coatings of this type are used, for example, in combustion chambers or as gas turbine blades or vanes.

Known processes for producing holding structures for ceramic thermal barrier coatings (TBC) include, in addition to the plasma spraying or flame spraying of bond layers described above, the processes of cavity sinking, laser/water jet/electron beam modeling, soldering and sintering of particles (DE 195 45 025 A1) or the production of a substantially network-like skeleton structure, which is cast at the same time, on the surface of the base body (EP 0 935 009 A1).

If the sandwich structure is sprayed with highly porous ceramic, it is possible to achieve layer thicknesses of up to 1.5 mm. However, these ceramics are extremely sensitive to impacts from foreign bodies, so that the service life of sandwich structures of this type is only very short, and therefore the structures often have to be exchanged or repaired.

In order, for example, to considerably reduce the consumption of cooling air in a gas turbine and thereby to increase efficiency, there is a need for a considerably more effective thermal barrier than that which is known from the prior art, for example from the document DE 195 45 025 A1.

This more effective thermal barrier can be achieved by the application of relatively thick TBC layers. However, to ensure sufficient adhesion of these thick layers to a base body, it is necessary for very coarse holding structures to be produced on the surface of the base body.

The applicant is aware of a process (DE 100 57 187.5) in which spherical or mushroom-shaped coarse holding structures (anchor points, also known as rivets) are produced on a surface by a welding process, in particular an arc welding process. In this case, to produce these holding structures, a preferably endless welding wire is melted down, the melted welding wire itself forming the specially shaped anchor points. Welded-on coarse anchor points of this type differ significantly from the integrally cast skeleton structures such as those which are known from EP 0 935 009 A1.

The composition of the welded-on material can advantageously in principle be selected as desired. This allows extensive consideration of the local situation, for example with regard to oxidation and corrosion. By contrast, the cast-on structure which is known from the document EP 0 935 009 A1 consists of the same material as the substrate. A further fundamental difference consists in the fact that the cast-on structure forms a continuous network, within which, after the coating, there are then individual islands of ceramic. By contrast, the welded structures have a continuous ceramic network with individual metal islands, which has a beneficial effect on the properties of the layer. For example, in particular the lower heat conduction, the smaller area of metal exposed to the oxidation and the improved anchoring of the ceramic layer with the welded structures compared to the cast network-like structures should be mentioned.

A drawback of this known process for producing the welded holding structures in which sphere-like or mushroom-like anchor points are formed by means of arc welding by melting off the welding wire and are welded onto the base body is that the formation of the anchor points has to be divided into a plurality of welding phases, which requires complicated control of the welding operation.

### SUMMARY OF THE INVENTION

The invention attempts to avoid this drawback. It is based on the object of providing a process for producing welded sandwich structures between metallic and nonmetallic materials, in particular for the construction of gas and steam turbines, and a sandwich structure between metallic and nonmetallic materials, in which, on the one hand, a considerable layer thickness of a nonmetallic material is applied to a metallic material in such a manner that it bonds stably and is insensitive to impacts, and, on the other hand, the process at the same time is simple to implement.

According to the invention, in a process in accordance with the preamble of patent claim 1, this is achieved by the fact that mushroom-shaped rivets comprising web and head are prefabricated in a first process step, in that in a second process step these rivets are sorted for mechanical further processing, oriented and introduced into a welding unit in such a manner that in a third process step the rivets are welded, in each case by means of the free end of the web, onto the surface of the base body, thereby forming anchor points for the nonmetallic material.

An advantage of this process is that the welding process is very simple and quick to implement and, through the use of differently shaped rivets, it is possible to adapt the shape and size of the anchor points to the different layer thicknesses for the sandwich structure. A further advantage of these processes is primarily that damaged sandwich structures can easily be repaired, since the sandwich structure, in particular the gas or steam turbine, no longer has to be dismantled and sent off for repair, but rather direct repair can be carried out on site. All that a repair of this type requires is for the prefabricated rivets to be in stock and for there to be a suitable welding unit.

Furthermore, the object of the invention is achieved by the fact that the bond layer comprises individual prefabricated rivets (anchor points) which have a web and a head and are welded onto the surface of the base body by means of the web.

An advantage in this case is that the anchor points can be positioned in a controlled manner, with the result that the strength of a sandwich structure of this type can be considerably increased. Since, moreover, the material, height and diameter of the rivets can be varied within wide limits and combined (cf. subclaims 3 to 6), the properties of the bond layer can advantageously be accurately matched to the prevailing load conditions.

### BRIEF DESCRIPTION OF THE DRAWING

The drawing illustrates an exemplary embodiment of the invention in the individual process steps. In the drawing:

FIG. 1 shows a side view of prefabricated rivets of different shapes;

FIG. 2 diagrammatically depicts the sorted, aligned and lined-up rivets for mechanical further processing;

FIG. 3 diagrammatically depicts the welding of the prefabricated rivets onto the surface of the base body, and

FIG. 4 diagrammatically depicts a finished sandwich structure between a metallic material and a nonmetallic material.

Only the features which are pertinent to the invention are illustrated.

### WAYS OF CARRYING OUT THE INVENTION

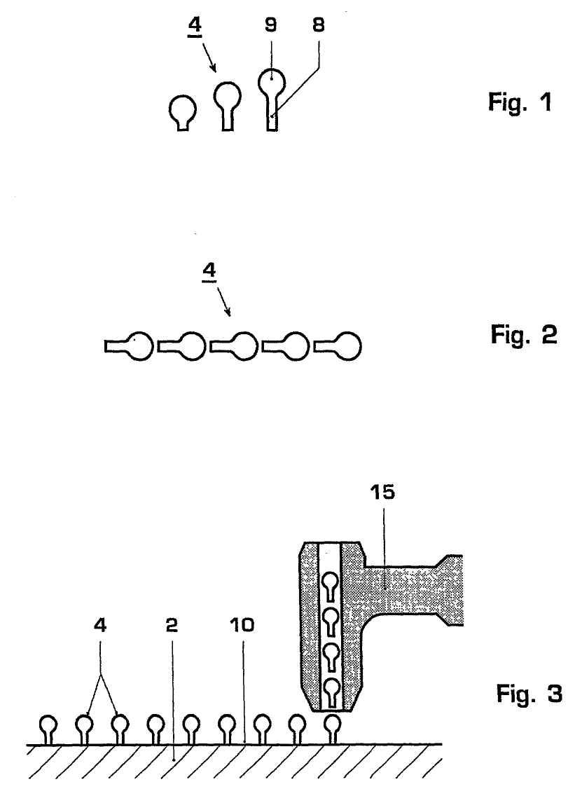

The invention is explained in more detail below with reference to exemplary embodiments and FIGS. 1 to 4.

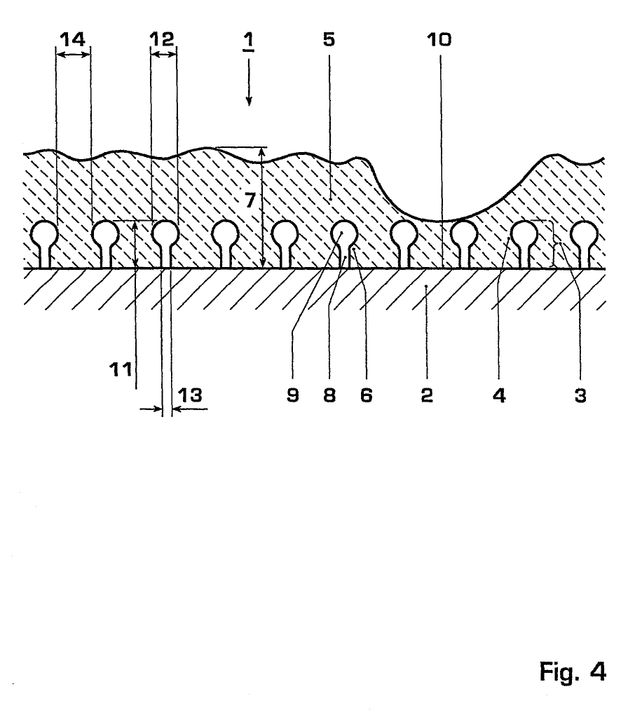

FIGS. 1 to 3 diagrammatically depict the individual steps of the process according to the invention, while FIG. 4 illustrates an example of the sandwich structure according to the invention.

In sandwich structures 1 of this type, as can be seen in particular from FIG. 4, a bond layer 3, which is formed from individual anchor points, in this case referred to as rivets 4, is applied to the surface of a metallic base body 2, and then a nonmetallic material 5 is applied to the bond layer. The base body 2 may, for example, consist of the materials IN 738, IN 939, MA 6000, PM 2000, CMSX-4, MARM 247 or the like, and the rivets 4 may consist of the materials MCrAlY, SV 20, SV 34, Haynes 214, IN 625, 316 L or the like. Any desired combinations of materials are possible.

According to the invention, the bond layer 3 is produced by a welding process, specifically a resistance welding process.

The first step of the process according to the invention consists in firstly prefabricating the rivets 4. This can take place, for example, by casting or forging.

The prefabricated rivets 4 have a mushroom-shaped structure and have a web 8 and a head 9. As can be seen from FIG. 1, the shape of the rivets 4 may vary, i.e. they may have different web heights and different web or head diameters. It is advantageous if the rivets 4 have a head diameter 12 of approx. 0.8 mm to 3 mm and a web diameter 13 of approx. 0.5 mm to 2 mm, and a height 11 of approx. 1 mm to 10 mm. This results in very good possibilities for anchoring the nonmetallic layer which is subsequently to be applied.

In a second process step (FIG. 2), the rivets 4 are sorted, oriented and lined up for mechanical further processing. Depending on the intended application, it is possible to combine rivets 4 made from different materials and with different shapes with one another. The lined-up rivets 4 are then introduced into a stud-welding unit 15 and are then resistance-welded rivet 4 by rivet 4 onto the surface 10 of the metallic base body 2, in each case by means of the free end of the web 8 (FIG. 3).

The special shape of the rivets 4 results in a suitable surface roughness being created, with the result that the nonmetallic material 5, which is to be applied in the liquid state, produces a positively locking join to the metallic base body 2, i.e. corresponding undercuts 6, in the form of free spaces between the rivets 4 and the base body 2, are formed by the rivets 4, into which undercuts the nonmetallic material 5 flows or becomes hooked, thus producing a secure join between the nonmetallic material 5 and the metallic material, in particular the base body 2. The nonmetallic material 5, for example ceramic, can be applied using known processes, such as plasma spraying or flame spraying.

It is essential for the production of a sandwich structure 1 of this type that a defined surface roughness with sufficient undercuts 6 be produced, so that a high strength and sufficient coating thickness 7 for the nonmetallic material 5 can be produced. A considerable coating thickness 7 has the effect, for example, of considerably reducing the consumption of cooling air in a gas turbine, so that the efficiency of the gas turbine is considerably increased. However, to ensure that a considerable coating thickness 7 can be created, it is necessary to form a significantly larger holding structure or more coarse bond layer 3 than is known from the prior art by the application of soldering pastes with additional elements or the like. Therefore, it can be stated that, depending on the shape and size of the rivets 4, a suitable coating thickness 7 for the nonmetallic material 5 can be applied to the base body 2.

In sandwich structures 1 of this type, as are used, for example, in gas or steam turbines, the nonmetallic material 5 applied should be sufficiently able to withstand impacts from foreign bodies without the nonmetallic material 5 being separated or detached from the metallic material, i.e. from the base body 2. However, if the nonmetallic material 5 should nevertheless become detached as a result of an impact from a foreign body on account of the force being excessive, it should be ensured that the surface of the sandwich structure 1 is only slightly disturbed. The special production of the bond layer 3, in particular the special design of the mushroom-shaped rivets 4, ensures that, in the event of an impact from a foreign body, only the material which projects beyond the rivets 4 is detached, whereas the nonmetallic material 5 between the rivets 4 is not separated from the sandwich structure 1. As a result, only small points of attack on the base body 2 above the rivets 4 are formed.

This is achieved to the extent that, on account of the specially defined design of the rivets 4 with web 8 and head 9, large-area undercuts 6 and a defined number of rivets 4 can be formed on a predetermined area, so that the nonmetallic material 5, which embeds the rivets 4, produces a very secure join thereto, and therefore this material can no longer be separated from the base body 2 between the individual rivets 4. The right-hand part of FIG. 4 diagrammatically depicts an illustration of this type after an impact from a foreign body during which part of the nonmetallic material 5 has been detached. It can be seen from this illustration that, in the event of an impact from a foreign body, although the nonmetallic material 5 above the rivets 4 has been detached, it remains securely in place between the rivets 4 and therefore only small amounts of heat can be transferred to the base body 2 via the rivets 4, so that undesired destruction of the sandwich structure 1 in the region of the impact from the foreign body can be prevented.

It is advantageous if the coating thickness 7 for the nonmetallic material 5 is between 1 mm and 20 mm, since in this way the component is able to withstand even very high temperature differences without problems.

Of course, it is possible for the production of large-area bond layers 3 from purely individual rivets 4 to be carried out using a welding robot, allowing rapid and controlled positioning of the individual rivets 4.

A significant advantage of these processes is primarily that damaged sandwich structures 1 can easily be repaired, since the sandwich structure 1, in particular the gas or steam turbine, no longer has to be dismantled and sent off for repair, but rather direct repair can be carried out on site. All that a repair of this type requires is for there to be prefabricated rivets 4 and a suitable welding unit. In this way, considerable costs, such as transport and idle time costs, can be saved.

Furthermore, it is possible, using a corresponding device, for a plurality of rivets 4 to be welded simultaneously onto the surface 10 of the base body 2, so that a considerable time saving can be achieved when arranging the rivets 4 over large areas.

A specific example which is described here is a thermal barrier plate for a gas turbine. The metallic plate consists of the material IN 939, having the following chemical composition: 22.5% Cr, 19% Co, 2% W, 1% Nb, 1.4% Ta, 3.7% Ti, 1.9% Al, 0.1% Zr, 0.01% B, 0.15% C, remainder Ni. It forms the metallic base body 2 which is to be coated with a ceramic layer 5. A bond layer 3 is applied to the surface 10 of the metallic base body 2. This bond layer 3 is formed from rivets 4, which consist of the highly oxidation-resistant material Haynes 214 (composition: 16% Cr, 2.5% Fe, 4.5% Al, Y, remainder Ni) and are prefabricated in a special mushroom-shaped mold with web 8 and head 9. The rivets 4 can be produced using known nail/rivet production processes, generally by forging, turning, machining, such as screw spin forming.

In the present exemplary embodiment, the prefabricated rivets 4 have a diameter 12 of the head 9 of 1 mm, a diameter 13 of the web 8 of 0.6 mm and a web height of 1.2 mm, corresponding to an overall height 11 of the rivets 4 of 2.2 mm.

These prefabricated rivets 4 are then oriented for mechanical further processing, lined up and introduced into a stud-welding unit 15. The rivets 4 are successively welded, in each case by means of the free end of the web 8, onto the surface of the metallic base body 2, i.e. the thermal barrier plate, the distance 14 between two adjacent heads 9 of the rivets 4 being approximately 1.5 mm.

It is generally the case that the distance 14 between two adjacent heads 9 of the rivets 4 should advantageously be in the range between 1 and 5 times the diameter 12 of the rivets 4. Greater distances 14 are also possible.

After the rivets 4 have been welded on and in this way the bond layer 3 has been applied, the plate is then coated with TBC by means of air plasma spraying. The TBC layer consists of yttrium-stabilized zirconia of the following chemical composition: 2.5% HfO₂, 7-9% Y₂O₃, <3% others, remainder ZrO. The coating height 6 is approx. 4.5 to 5 mm.

A thermal barrier plate which had been coated in this way was subjected to a thermal shock test from 1200° C. to room temperature. A flame was used for heating (1200° C.) on the TBC side, while on the base body side compressed air was used for cooling (900° C.). 850 thermal cycles were completed without any flaking of the TBC layer. This demonstrates the excellent anchoring possibilities of the ceramic material 5 in the bond layer 3 comprising the welded-on rivets 4.

### List of Reference Symbols

1 Sandwich structure

2 Metallic base body

3 Bond layer

4 Rivet (anchor point)

5 Nonmetallic material

6 Undercut

7 Coating thickness of 5

8 Web of 4

9 Head of 4

10 Surface of 2

11 Height of 4

12 Diameter of 9

13 Diameter of 8

14 Distance between two adjacent heads of 4

15 Welding unit

1. A process for producing sandwich structures (1) between metallic and nonmetallic materials, in which a bond layer (3) is applied to a surface (10) of a metallic base body (2), a nonmetallic material (5) is then applied to the bond layer, and in which the bond layer (3) is produced from individual welded-on rivets (4) which have a mushroom-like shape with web (8) and head (9), characterized
in that the rivets (4) are prefabricated in a first process step,
in that in a second process step these rivets (4) are sorted for mechanical further processing, oriented and introduced into a welding unit (15) in such a manner that
in a third process step the rivets (4) are successively welded, in each case by means of the free end of the web (8), onto the surface (10) of the metallic base body (2), thereby forming anchor points for the nonmetallic material (5).

2. A sandwich structure (1) between metallic and nonmetallic materials, in which a bond layer (3) is arranged on a surface (10) of the metallic material, which forms a base body (2), and the nonmetallic material (5) is applied to the bond layer, characterized in that the bond layer (3) comprises individual prefabricated mushroom-shaped rivets (4) which have a web (8) and a head (9) and are welded onto the surface (10) of the base body (2) by means of the web.

3. The sandwich structure (1) as claimed in claim 2, characterized in that the rivets (4) have a diameter (12) of the head (9) of approx. 0.8 mm to 3 mm and a diameter (13) of the web (9) of approx. 0.5 mm to 2 mm.

4. The sandwich structure (1) as claimed in claim 2, characterized in that the rivets (4) have a height (11) of approx. 1 mm to 10 mm.

5. The sandwich structure (1) as claimed in claim 2, characterized in that the distance (14) between two adjacent heads (9) of the rivets (4) is approx. 1 to 5 times the diameter (12) of the head (9).

6. The composite structure (1) as claimed in claims 2 to 5, characterized in that the metallic base body (2) preferably consists of IN 738, IN 939, MA 6000, PM 2000, CMSX-4 and MARM 247, the rivets (4) preferably consist of MCrAlY, Haynes 214, IN 626, 316 L, SV 20 and SV 34, and the nonmetallic material (5) is ceramic material, preferably yttrium-stabilized zirconia.

7. The sandwich structure (1) as claimed in claim 2, characterized in that the coating thickness (7) for the nonmetallic material (5) is between 1 mm and 20 mm.
